(19) United States
(12) Patent Application Publication
(10) Pub. No.: US 2012/0044959 A1
(43) Pub. Date: Feb. 23, 2012

(54) TERAHERTZ SOURCE

(75) Inventors: Pu ZHAO, Bethlehem, PA (US); Srinivasa Rao RAGAM, Bethlehem, PA (US); Yujie J. DING, Center Valley, PA (US)

(73) Assignee: LEHIGH UNIVERSITY, Bethlehem, PA (US)

(21) Appl. No.: 13/154,482

(22) Filed: Jun. 7, 2011

Related U.S. Application Data
(60) Provisional application No. 61/375,070, filed on Aug. 19, 2010.

(51) Int. Cl. H01S 3/11; H01S 3/10

(52) U.S. Cl. 372/10; 372/21

(57) ABSTRACT

An optical system includes a first gain medium configured to be excited by an energy source and in response generate a first optical signal having first and second wavelengths. A Q-switch is disposed adjacent to the first gain medium for generating a pulsed optical signal in response to receiving the first optical signal. A non-linear optical crystal is configured to output a second optical signal having a frequency based on difference frequency generation of the first and second wavelengths of the pulsed optical signal.

### CROSS-REFERENCE TO RELATED APPLICATIONS

This application claims priority to U.S. Patent Application No. 61/375,070, filed on Aug. 19, 2010, the entirety of which is herein incorporated by reference.

### STATEMENT OF GOVERNMENT INTEREST

This invention was made with Government support under grant 0925054 from the National Science Foundation and contract N0014-10-1-0290 awarded by the Office of Naval Research. The Government may have certain rights in this invention.

### FIELD OF DISCLOSURE

The disclosed systems and methods relate to optical systems. More specifically, the disclosed systems and methods relate to optical signal generators capable of generating signals having frequencies on the order of terahertz (“THz”).

### BACKGROUND

Terahertz sources or emitters may be usefully incorporated into a wide range of devices. For example, a terahertz source may be used in analyzers for determining an amount of light having a terahertz frequency that is absorbed. Such analyzers may be used by chemists, biochemists, and material scientists to analyze chemical species, biological samples, biomedical species, pharmaceutical products, and other materials.

Terahertz sources may also be used in imaging devices. For example, such high-frequency sources may be incorporated into airport security scanners to detect and identify knives, guns, and other weaponry or contraband. Unlike x-rays which ionize the human body, terahertz sources do not ionize the body so they provide increased safety compared to conventional x-ray machines.

However, conventional terahertz sources have large footprints and require substantial space in which they can be implemented. Additionally, conventional terahertz sources have very low operating temperatures and need to be cryogenically cooled. These drawbacks have limited terahertz sources to laboratory settings instead of being widely available for commercial uses.

### SUMMARY

In some embodiments, an optical system includes a first gain medium configured to be excited by an energy source and in response generate a first optical signal having first and second wavelengths. A Q-switch is disposed adjacent to the first gain medium for generating a pulsed optical signal in response to receiving the first optical signal. A non-linear optical crystal is configured to output a second optical signal having a frequency based on difference frequency generation of the first and second wavelengths of the pulsed optical signal.

In some embodiments, a method includes generating a first optical signal having first and second wavelengths in response to exciting a first gain medium, switching the first optical signal to provide a pulsed optical signal having the first and second wavelengths, and outputting a second optical signal from a non-linear optical crystal in response to receiving the pulsed optical signal. The second optical signal has a frequency based on difference frequency generation of the first and second wavelengths of the pulsed optical signal.

In some embodiments, an optical system includes a first energy source configured to output optical energy having a first wavelength, a first gain medium configured to output a first optical signal having second and third wavelengths in response to receiving the optical energy from the first optical source, and a Q-switch disposed adjacent to the first gain medium for generating a pulsed optical signal in response to receiving the first optical signal. A non-linear optical crystal is configured to output a second optical signal having a frequency on an order of a terahertz based on difference frequency generation of the pulsed optical signal having the second and third wavelengths.

### BRIEF DESCRIPTION OF THE DRAWINGS

These and other features and advantages of the disclosed systems and methods will be more fully disclosed in, or rendered obvious by the following detailed description of the preferred embodiments, which are to be considered together with the accompanying drawings wherein like numbers refer to like parts and further wherein:

FIG. 1 illustrates one example of a single-gain medium terahertz source;

FIG. 2 illustrates an example of a single gain medium terahertz source configured with multiple Q-switches;

FIG. 3 illustrates an example of a terahertz source having multiple gain mediums;

FIG. 4 illustrates an example of a terahertz source having multiple gain mediums and multiple Q-switches;

FIG. 5 illustrates an example of tunable terahertz source having a single gain medium;

FIG. 6 illustrates an example of a tunable terahertz source having multiple gain mediums;

FIG. 7 is a graph of output power versus pump power for terahertz source in accordance with FIG. 1;

FIG. 8 illustrates the measured pulse shapes of two output beams for a terahertz source in accordance with FIG. 1;

FIG. 9 is a graph of the average output power versus input power of a terahertz source in accordance with FIG. 1;

FIG. 10 is an intensity versus displacement graph of a terahertz source in accordance with FIG. 1;

FIG. 11 is a graph of output power versus pump power for terahertz source in accordance with FIG. 3;

FIG. 12 is a graph of the average output power versus input power of a terahertz source in accordance with FIG. 3;

FIG. 13 is an intensity versus angle graph of a terahertz source in accordance with FIG. 3; and

FIG. 14 is an intensity versus displacement graph for a terahertz source in accordance with FIG. 3.

### DETAILED DESCRIPTION

Optical systems and methods are disclosed for generating optical signals having frequencies on the order of terahertz. These optical systems, sometimes referred to as terahertz sources, may be implemented in a more compact design, i.e., having a size on the order of a laser pointer or a shoebox, compared to conventional terahertz sources that are many times larger. Additionally, these improved terahertz sources may operate at room temperature without the need to be cryogenically cooled and therefore lend themselves to being incorporated into commercial devices.

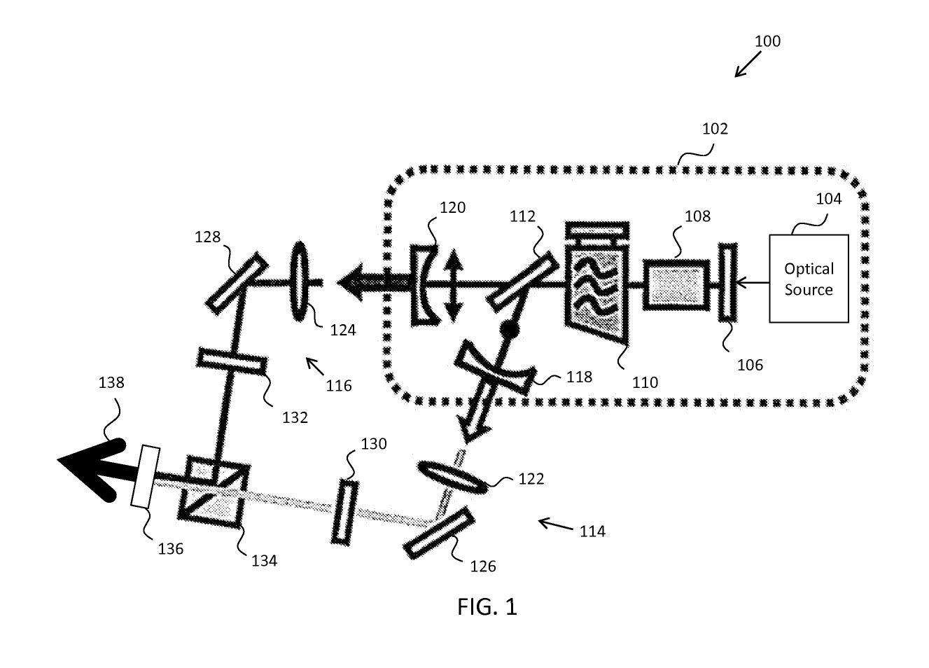

FIG. 1 illustrates one example of an improved terahertz source 100 having a cavity 102 in which an optical source 104, an input mirror 106, a gain or lasing medium 108, and a Q-switch 110 are disposed. A polarizer 112 is also disposed in cavity 102 between Q-switch 110 and arms 114, 116.

Arms 114, 116 respectively include an output coupler 118, 120, lenses 122, 124, mirrors 126, 128, and half-wave plates 130, 132. Half-wave plates 130, 132 are respectively disposed adjacent to mirrors 126, 128 and beam splitter 134. Beam splitter 134 is configured to combine the optical signals received from half-wave plates 130, 132 and output a combined optical signal to non-linear optical (“NLO”) crystal 136.

Optical source 104 is capable of pumping gain medium 108 with optical energy such that gain medium 108 emits pair of wavelengths, λ1 and λ2, as described below. In some embodiments, optical source 104 is a flash lamp, a laser diode, or any other device capable of providing optical energy of at least one wavelength to gain medium 108.

Mirror 106 may be any partially reflective medium as will be understood by one skilled in the art. For example, mirror 106 may be a plano input mirror having a coating for producing a high transmittance, e.g., a transmittance of greater than 95 percent, along with a high reflectivity, e.g., a reflectivity of greater than 99 percent.

Gain medium 108 may be implemented as a ytterbium-doped ytterbium aluminum garnet (Yb:YAG) crystal, a neodynium-doped YAG (Nd:YAG) crystal, a neodymium-doped yttrium lithium fluoride (Nd:YLF) crystal, or other solid-state laser crystal. Gain medium 108 generates a pair of perpendicularly polarized beams having differing wavelengths, λ1 and λ2, which are used to achieve difference frequency generation (“DFG”). For example, lasing medium 108 may emit a first wavelength λ1 of 1047 nm and a second wavelength λ2 of 1053 nm in response to being excited by a third wavelength from optical source 104, e.g., 808 nm. One skilled in the art will understand that other wavelengths may be generated by gain medium 108 in response to optical source 104.

Q-switch 110 is disposed adjacent to gain medium 108 and may be an active or passive device. Examples of active Q-switches 110 include, but are not limited to, an acoustic-optic Q-switch, an externally-controlled variable attenuator, a shutter, a spinning prism, or the like. In embodiments where Q-switch 110 is a passive device, Q-switch 110 may be implemented as an ion-doped crystal such as chromium doped YAG (Cr:YAG). Q-switch 110 may also include one or more Q-switches in combination. For example, Q-switch 110 may include an acoustic-optic Q-switch and a passive ion-doped Q-switch to enhance the gain of terahertz source 100.

Polarizer 112 is configured to divert and/or combine polarized beams emitted from a gain medium 108. Coatings may be applied to polarizer 112 such that when polarizer 112 is placed at a Brewster's angle relative to the input beam received from Q-switch 110, which includes two polarized beams, one polarized beam has a high transmittance through the polarizer, e.g., a transmittance of greater than 95 percent, and the other polarized beam has a high reflectivity of the polarizer, e.g., a reflectivity of greater than 99 percent.

Output couplers 118 and 120 may be any suitable device for outputting the polarized optical signals from cavity 102. In some embodiments, output couplers 118 and 120 are arranged such that one output coupler, e.g., output coupler 118, induces a larger loss than the other output coupler, e.g., output coupler 120, in order to balance the output powers of the polarized beams. The loss may be introduced by tilting output coupler 118 such that it does not orthogonally receive the polarized beam or by adjusting the reflectivity of the optical coupler. One skilled in the art will understand that the output power of the polarized beams may be adjusted using other techniques.

Arms 114 and 116 direct the polarized beams from output couplers 118, 120 to beam splitter 134 using lenses 122, 124, mirrors 126, 128, and half-wave plates 130, 132. Lenses 122, 124 may be convex lenses having the same focal length for collimating the beams output from output 122, 124, and mirrors 126, 128, may be any mirror having a high reflectivity for directing the collimated, polarized beams to beam splitter 134. Half-wave plates 130, 132 may be any optical device configured to alter the polarization of optical signals.

Beam splitter 134 may be any device for combining the polarized beams such that the beams overlap in time and space. In some embodiments, beam splitter 134 is a polarization cube as will be understood by one skilled in the art.

Crystal 136 may be any non-linear optical crystal. Examples of non-linear optical crystals include, but are not limited to, gallium selenide (GaSe) crystals, gallium phosphide (GaP) crystals, gallium arsenide (GaAs) crystals, zinc-germanium diphosphide (ZnGeP₂) crystals, barium borate (BBO) crystals, lithium triborate (LBO) crystals, potassium titanyl phosphate (KTP) crystals, lithium niobate (LiNbO₃) crystals, silver gallium sulfide (AgGaS₂) crystals, and silver gallium selenite (AgGaSe₂) crystals, to name a few possibilities. One skilled in the art will understand that the selection of the non-linear crystal may depend on the desired wavelength of the optical beams emitted from gain medium 108.

In operation, optical source 104 pumps lasing medium 108 with photonic energy through mirror 106. The ions in lasing medium 108 are excited by the photonic energy received from optical source 104 causing light having two specific wavelengths, i.e., λ1 and λ2, to be emitted from lasing medium 108. Q-switch 110 is disposed adjacent to lasing medium 108 such that Q-switch 110 is shared by the two arms 114, 116 and synchronizes the pulses at both wavelengths λ1 and λ2. Polarizer 112 directs the light beam of wavelength λ1 into one cavity, e.g., towards output coupler 118 and arm 114, and the light beam of wavelength λ2 into a second cavity, e.g., towards output coupler 120 and arm 116.

The beams are output through their respective output couplers 118, 120 into respective arms 114, 116. In arm 114, the beam is collimated at lens 122 and directed to beam splitter 134 by mirror 126 and half-wave plate 130. Similarly, the beam in arm 116 is collimated by lens 124 and directed to beam splitter 134 by mirror 128 and half-wave plate 132. Beam splitter 134 combines the two beams received from arms 114 and 116 and outputs a single beam having two wavelengths, i.e., λ1 and λ2.

The beam output by beam splitter 134 is received at NLO crystal 136. The two wavelengths received at NLO crystal 134 undergo DFG such that an optical signal is output from NLO crystal 134 having a frequency that is on the order of terahertz.

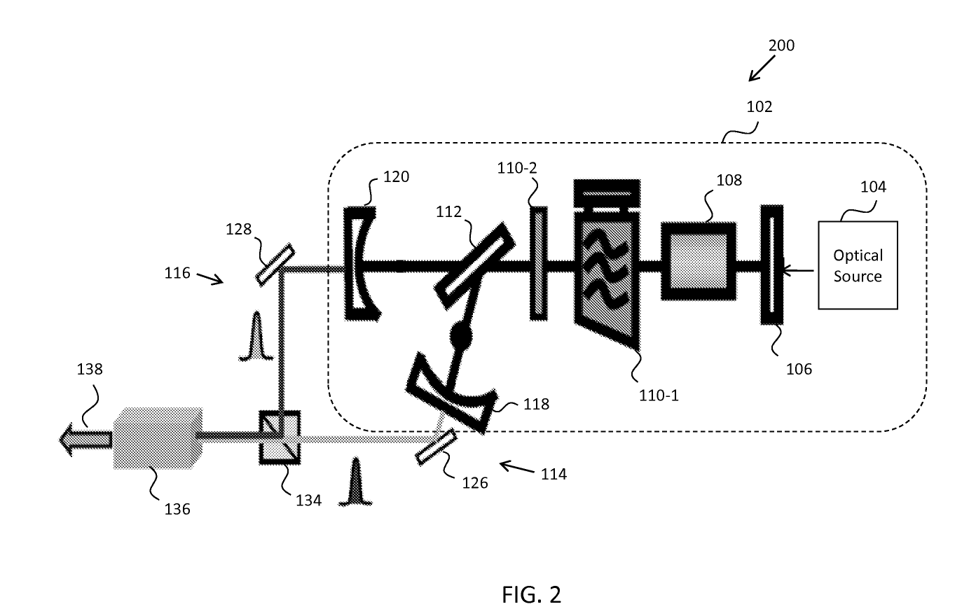

The power output of a terahertz source may be scaled by including multiple Q-switches as illustrated in the embodiment of FIG. 2. As shown in FIG. 2, terahertz source 200 includes Q-switch 110-1 and Q-switch 110-2 (“Q-switches 110”) in cavity 102. In some embodiments, Q-switch 110-1 is an active Q-switch and Q-switch 110-2 is a passive Q-switch. For example, Q-switch 110-1 may be an acoustic-optic Q-switch and Q-switch 110-2 may be a doped ion crystal such as a Cr⁴⁺ HYAG crystal. The inclusion of passive Q-switch 110-2 and active Q-switch 110-1 enables the pulse width of the beams output from lasing medium 108 in response to optical source 104 to be reduced, which results in the average power output to be increased by 10 μW or more. In some embodiments, the reduction of the pulse width can be down to several nanoseconds.

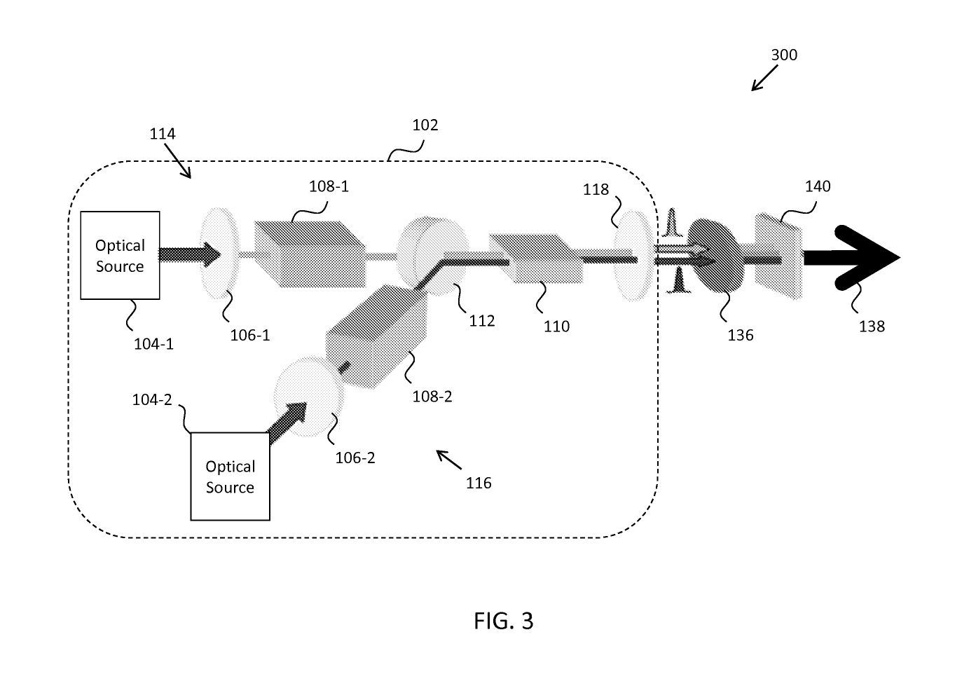

FIG. 3 illustrates an embodiment in which two optical sources 104-1 and 104-2 (“optical sources 104”), two input mirrors 106-1 and 106-2 (“input mirrors 106”), and two lasing or gain mediums 108-1 and 108-2 (“lasing mediums 108”) are implemented to provide a terahertz source 300 having an increased output power. As shown in FIG. 3, optical sources 104, mirrors 106, lasing mediums 108, a polarizer 112, and a Q-switch 110 are disposed within cavity 102.

Polarizer 112 is disposed between lasing mediums 108 and Q-switch 110 instead of between Q-switch 110 and output couplers 118 and 120 as in terahertz source 100 illustrated in FIG. 1. Polarizer 112 combines the beams output from lasing mediums 108 in response to being pumped by optical sources 104 into multi-wavelength beam directed at Q-switch 110. Q-switch 110 outputs a pulsed multi-wavelength beam through output coupler 118 to NLO crystal 136. At NLO crystal 136, the multi-wavelength beam undergoes DFG such that the beam output from NLO crystal 136 has a frequency in the terahertz range. The output of NLO crystal 136 may be passed through a PE filter 140, which has high reflection for the pump beam and high transmission for terahertz signal 138.

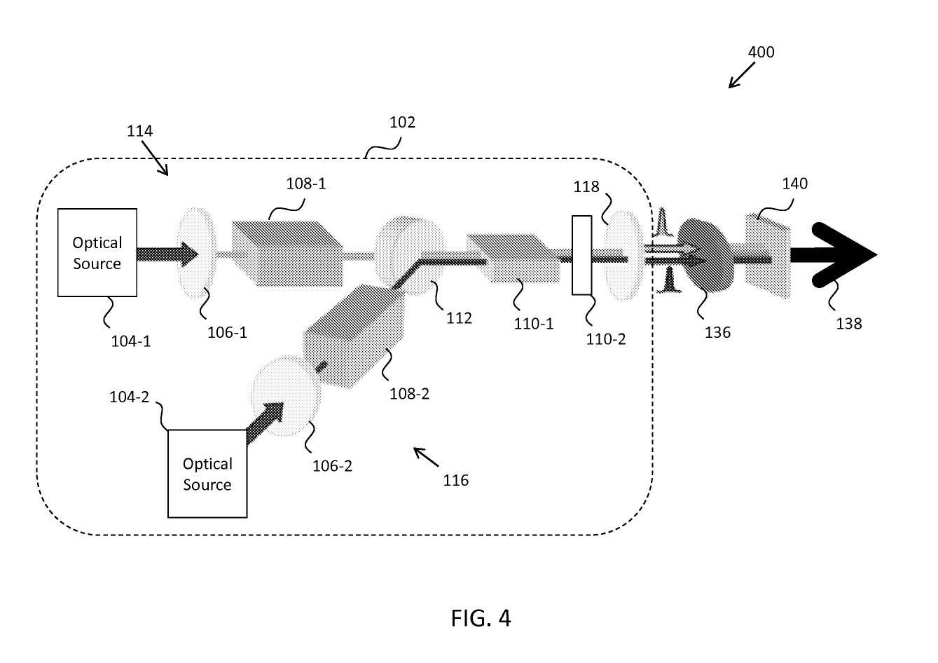

FIG. 4 illustrates an embodiment in which a second Q-switch 110-2 is implemented in the two-lasing medium design of FIG. 3. Terahertz source 400 illustrated in FIG. 4 includes a passive Q-switch 110-2, which may be an ion-doped crystal, disposed between active Q-switch 110-1 and output coupler 118. As described above, the inclusion of both passive and active Q-switches 110 enables the pulse width of the beams output from lasing mediums 108 in response to optical sources 104 to be reduced, which increases the output power.

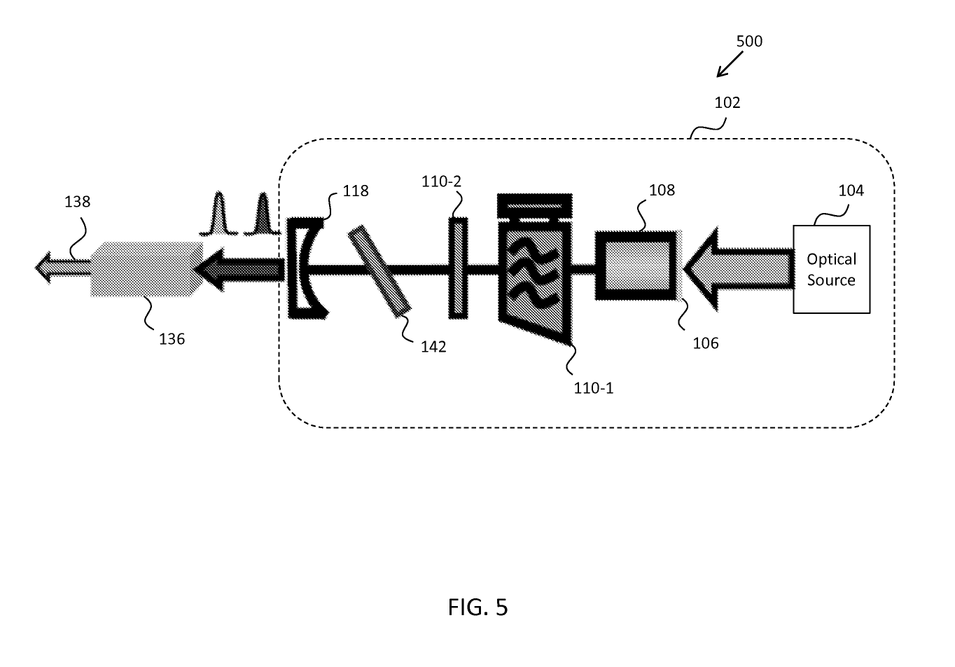

A terahertz source may also be implemented that enables the frequency of the output signal to be tuned. FIG. 5 illustrates a terahertz source 500 configured for providing tunability. Terahertz source 500 includes a cavity 102 in which an optical source 104, lasing medium 108, Q-switches 110, and output coupler 118 are disposed. A back reflector 106 is disposed on lasing medium 108 instead of a separate mirror as illustrated in the embodiments of FIGS. 1-5, and an etalon 142 is disposed between Q-switch 110-2 and output coupler 118. Etalon 142 may be a Fabry-Perot interferometer as will be understood by one skilled in the art. The inclusion of etalon 142 in terahertz source 500 enables the output to range in frequency from approximately 100 GHz to approximately 10 THz.

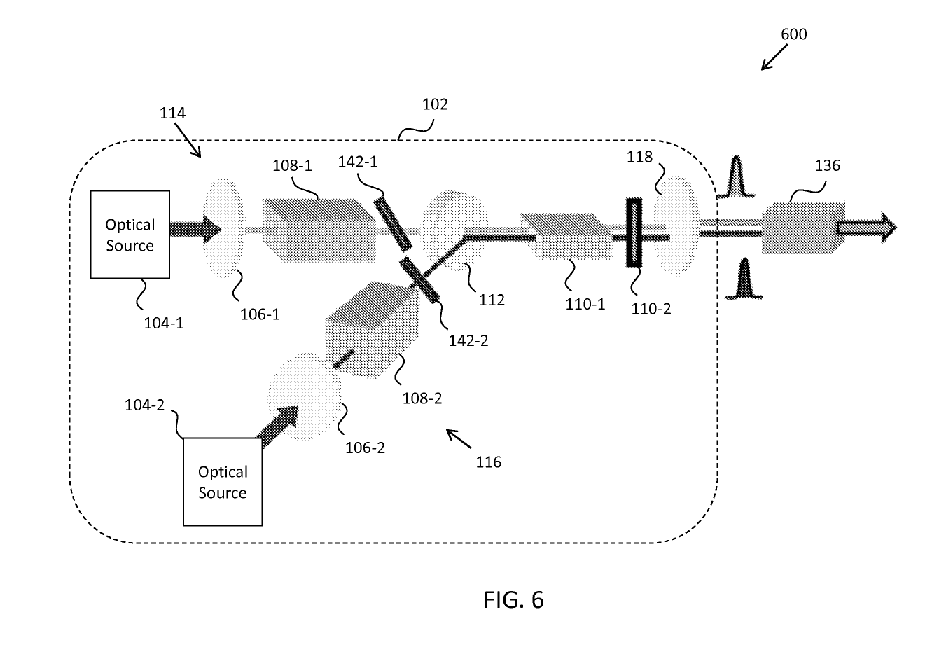

FIG. 6 illustrates an embodiment of a tunable terahertz source 600 in which multiple optical sources 104, mirrors 106, and lasing mediums 108 are implemented. The embodiment illustrated in FIG. 6 is similar to the embodiment in FIG. 4 except that terahertz source 600 includes etalons 142-1 and 142-2 (“etalons 142”) respectively disposed between lasing mediums 108-1, 108-2 and polarizer 112. Etalons 142 enables the output of terahertz source 600 to range in frequency from approximately 100 GHz to approximately 10 THz by adjusting the wavelengths of the optical signals output from lasing mediums 108.

Single Gain Medium Experiment and Results

A terahertz source similar to terahertz source 100 illustrated in FIG. 1 was designed and tested. The overall size of the terahertz source was approximately 12 inches by 12 inches by six inches. In the experiment, a one percent Nd-doped YLF (4×4×10 mm³) crystal was used as lasing medium 108 and produced frequencies of 286.5 THz and 284.9 THz. The produced frequencies corresponded to wavelengths of 1047 nm and 1053 nm being produced by lasing medium 108 in response to being pumped by an optical source. The transition produced by the Nd:YLF crystal having a wavelength of approximately 1047 nm had a cross-section of approximately 1.8×10⁻¹⁹ cm⁻², and the transition having the wavelength of 1053 nm had a cross section of approximately 1.2×10⁻¹⁹ cm⁻².

The two beams of differing wavelengths were collimated using two convex lenses having the same focal length and combined by a polarization cube. The terahertz source was arranged such that the optical paths of the two beams were the same and the beams overlapped in both time and space. These beams were focused on a 15 mm long GaSe crystal using a convex lens disposed adjacent to the NLO crystal. After DFG, the residual pump beams were blocked using a white polyethylene filter and collected using a beam dump. The generated THz beam was collected by two off-axis parabolic mirrors and then focused onto a power meter. The output frequency of the terahertz source was approximately 1.643 THz, which corresponds to a wavelength of 182.42 μm. The source consumed electrical power of less than 20 W.

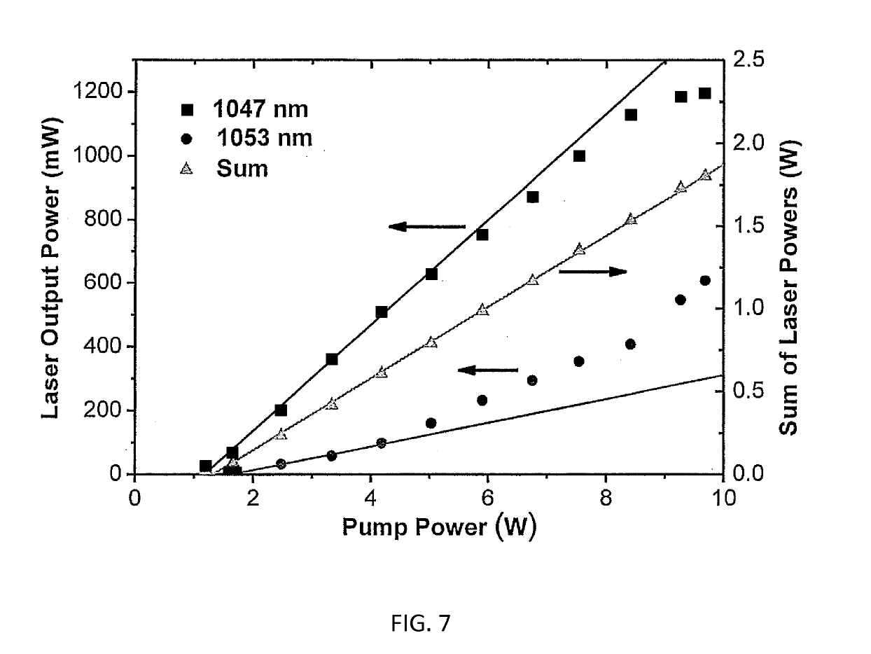

FIG. 7 illustrates the dependence of the Q-switched output powers of the 1047 nm and 1053 nm as well as their sum as a function of the pump power of the optical source. The lasing thresholds were measured to be approximately 1.17 W at 1047 nm and 1.64 W at 1053 nm. As seen in FIG. 7, both of the output powers of the 1047 nm and 1053 wavelengths linearly increased for pump powers of less than five Watts, with the power of the 1047 nm wavelength being higher than the power of the 1053 wavelength.

The output power of the 1047 nm wavelength becomes slightly saturated at pump powers of greater than five Watts whereas the output power of the 1053 nm wavelength increases at a greater rate at pump powers of greater than five Watts. This phenomenon is due to the two transitions accessing the same population inversion in the upper lasing level. When the gain for one transition was saturated, the gain for the second transition was increased.

The output powers were measured as a function of the repetition rate and it was determined that the optimal repetition rate of the Q-switch was 3.9 kHz. At a pump power of 9.69 W, the wavelength of 1047 nm had an output power of 1.196 W and the wavelength of 1053 nm had an output power of 0.608 W corresponding to a conversion efficiency of approximately 18.6 percent.

M² factors were measured to be 5.18 for the 1047 nm wavelength and 3.07 for the 1053 nm wavelength at a pump power of 5.9 W. The poorer beam quality for the 1047 nm wavelength was attributed to the tilting of the output mirror that was done to reduce the ratio of the output powers of the two transitions.

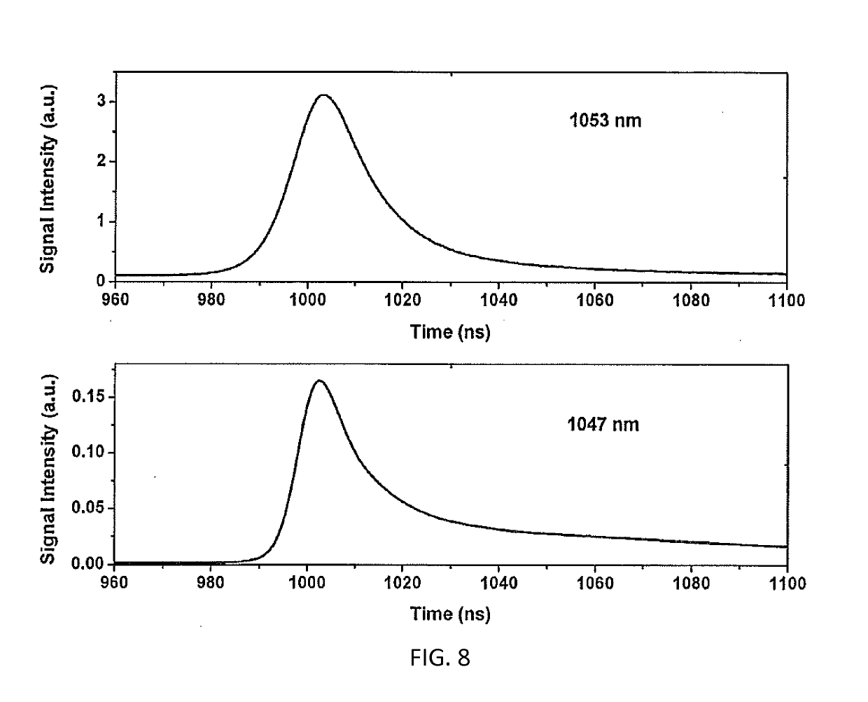

FIG. 8 illustrates the pulse shapes of the two output beams, which were measured using photodiodes. As shown in FIG. 8, the two pulses were synchronized. The pulse width of the 1047 nm wavelength at a pump power of 9.69 W was approximately 15.47 ns, and the pulse width of the 1053 nm wavelength at the same pump power was approximately 18.59 ns.

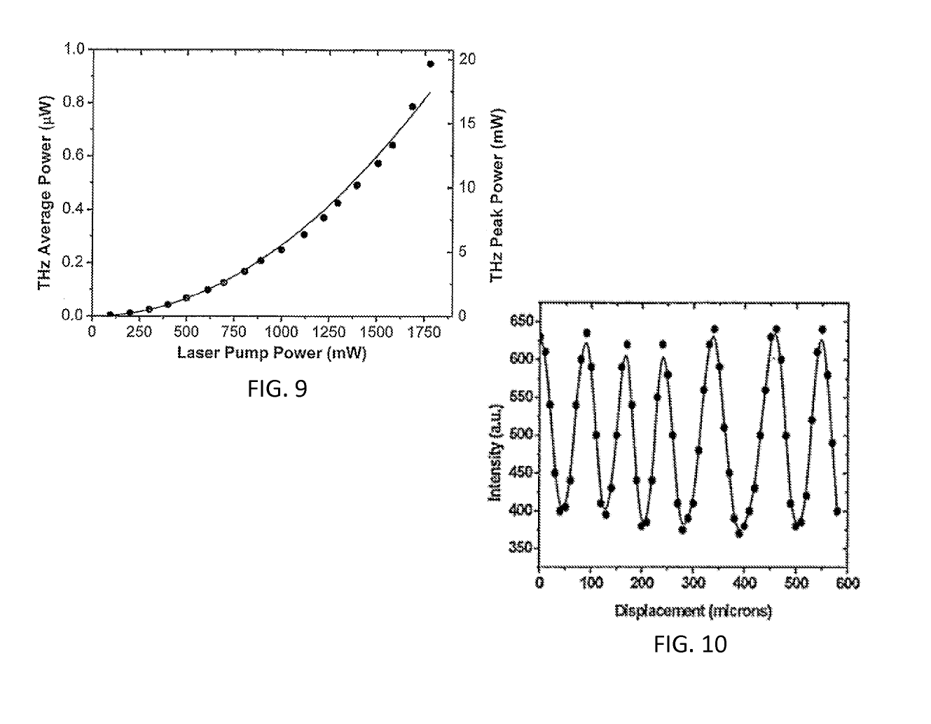

FIG. 9 is a plot of the dependence of the average and peak output powers on the sum of the output powers generated by the Nd:YLF laser as the input powers for DFG. The solid curve in FIG. 9 corresponds to the quadratic fit to the data points. When the sum of the input powers was 1.8 W, the average output power from the GaSe crystal was measured at approximately 0.948 μW, which corresponds to a conversion efficiency of approximately 5.26×10⁻⁵ percent. The pulse width of the THz beam was determined to be 12.36 ns by measuring the sum-frequency signal in a KTP crystal. Based on these measurements, the highest THz peak power was determined to be 19.7 mW. The linewidth of the THz wave was estimated to be 65 GHz, which was determined by measuring the linewidth of the sum-frequency signal at full-width half-maximum (“FWHM”), i.e., 0.06 nm. The output wavelength of the terahertz source was measured by a silicon etalon and is illustrated in FIG. 10.

Multiple Gain Medium Experiments and Results

A terahertz source similar to terahertz source 300 illustrated in FIG. 3 was designed and tested. Two one percent Nd-doped YLF (4×4×10 mm³) crystals were placed in two divided arms 114, 116 decoupled by polarizer 112. The Nd:YLF crystals were each pumped by a diode pumping beams at 808 nm that were collimated and focused onto the Nd:YLF crystals through convex lenses. The inclusion of two gain or lasing mediums 108 provided transition beams having wavelengths of 1047 nm and 1053 nm with access to their own population inversions.

An acoustic-optic Q-switch was placed at the shared arms of the two cavities to provide dual-frequency pulses that were synchronized and simultaneously modulated. The diode pumps were separately tuned such that the build-up time for the two lasers pulses was the same. The pulse build-up time is the time for generating a laser pulse when a Q-switch is open. As will be understood by one skilled in the art, the build-up time is based on the stimulated emission cross section of the gain medium, loss of the cavity, output coupling coefficient, and pumping level above the threshold. The repetition rate of the Q-switch was set at 5 kHz.

The output coupler was a concave mirror having a curvature of 15 cm and a reflectivity of 75 percent at both 1047 nm and 1053 nm. The two beams collinearly propagated since they were emitted from the same output coupler, and the THz output beam was generated by frequency mixing in a 15 mm GaSe crystal disposed directly after the output coupler.

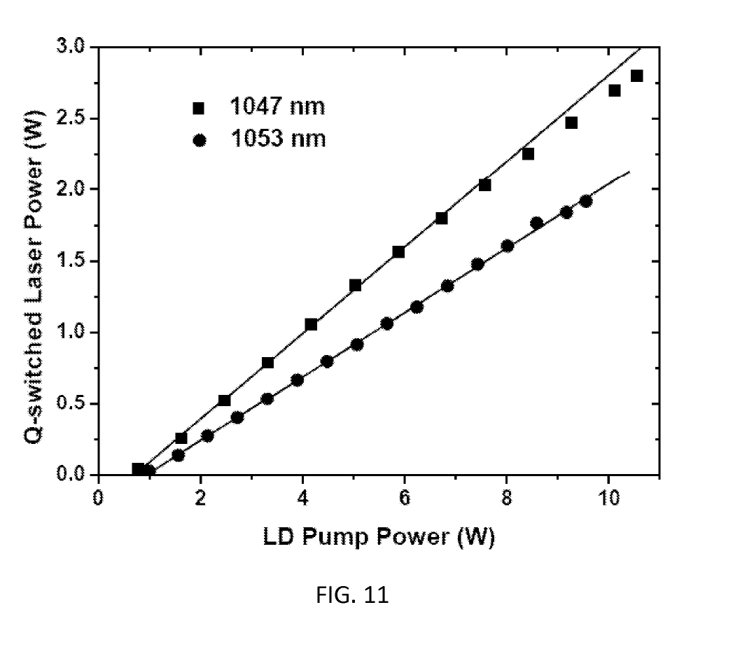

FIG. 11 illustrates the dependence of the Q-switched output powers of the 1047 nm and 1053 nm as a function of the pump power of the optical source. As seen in FIG. 11, the beam of wavelength 1047 nm had an output power of approximately 2.8 W in response to a pump power of approximately 10.55 W, and the beam of wavelength 1053 nm had an output power of approximately 1.918 W in response to a pump power of approximately 9.55 W. The conversion efficiency for the beam of wavelength 1047 nm was 26.5 percent, and the conversion efficiency for the beam of wavelength 1053 nm was 20.1 percent. The multi-crystal terahertz source exhibited a total output power that was more than twice the output power of the single-crystal terahertz source.

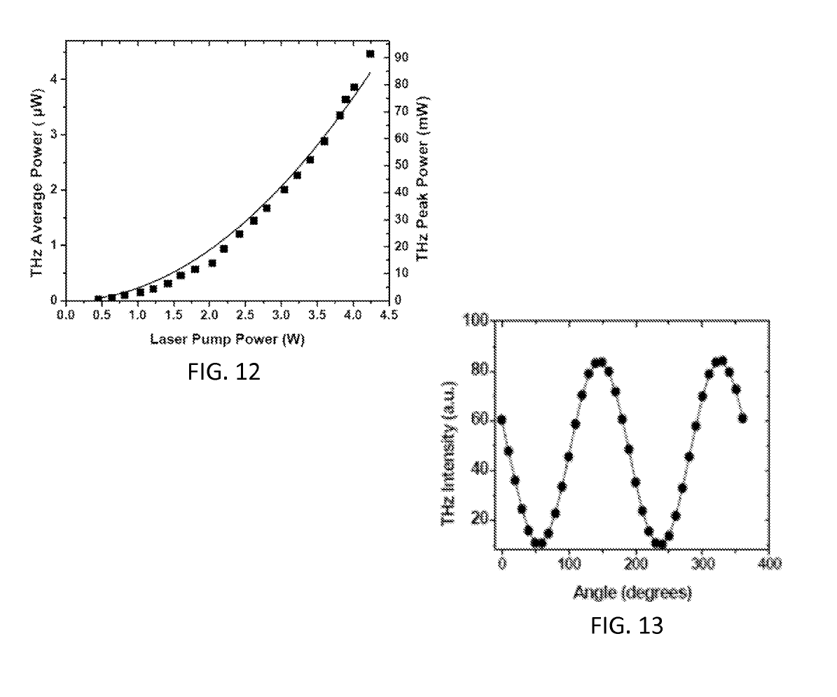

The power dependence of the terahertz source is illustrated in FIG. 12. As illustrated in FIG. 12, the output power dependence of the terahertz source is approximately quadratic, and an output power of 4.464 μW was achieved for operating a frequency of 1.643 THz (a wavelength of 182. μm) in response to an incident power of 4.24 W.

The pulse width of the beam of wavelength 1047 nm was measured to be 17.7 ns, and the pulse width of the beam of wavelength 1053 nm was measured to be 11.71 ns. Line widths of 77.5 GHz and 76.5 GHz were respectively measured for the beams of wavelengths 1047 nm and 1053 nm. FIG. 13 is a graph of the polarization of the terahertz radiation as a function of the azimuthal angle of the polarizer.

An experiment was also performed to demonstrate that different terahertz output frequencies may be obtained by selecting different gain mediums. For example, one Nd:YLF crystal was replaced by a 10 mm-long one percent Nd-doped YAG crystal resulting in transition beams having wavelengths of 1053 nm and 1064 nm being generated as the remainder of the optical components were left unchanged. The output power of the transition beam of wavelength 1053 nm was 1.981 W and was generated by a pump power of 9.55 W. The output power of the transition beam of wavelength 1064 nm was 1.706 and was generated by a pump power of 8.653 W. The respective measured pulse widths of the beams of wavelengths 1053 nm and 1064 nm were 9.92 ns and 12.48 ns, and the respective measured laser linewidths were 76.5 GHz and 75 GHz.

Radiation having a frequency of 2.983 THz, which corresponds to a wavelength of 100.5 μm, was generated by mixing the two laser beams in a GaSe crystal. The external phase-matching angle for the type II DFG was measured to be 18.3°, and the maximum output power was 2.09 μW. The lower output power of the terahertz source utilizing a Nd:YAG crystal instead of a Nd:YLF crystal is attributed to increased absorption of the terahertz radiation by the GaSe crystal.

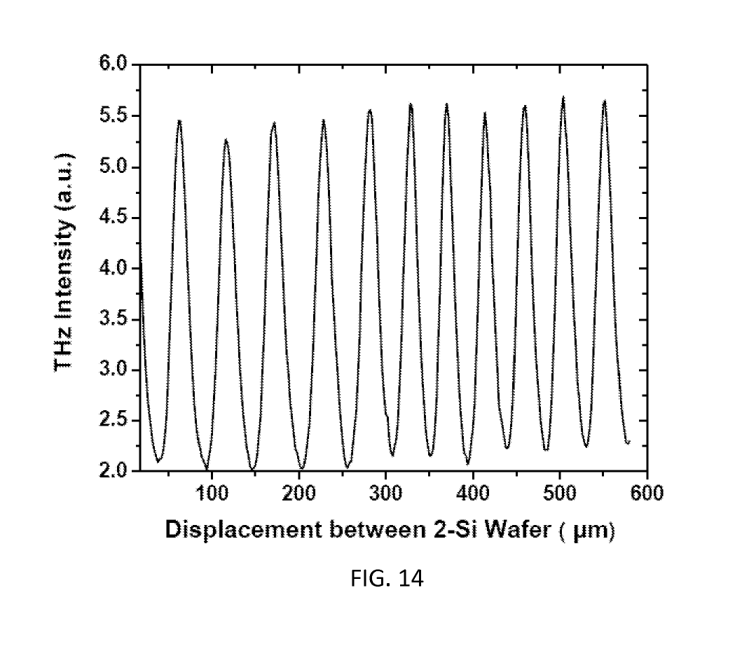

The output wavelength of the terahertz signal was measured by scanning a silicon-based etalon and the results are graphically illustrated in FIG. 14. As shown in FIG. 14, the output wavelength is approximately 98 μm, which is close to the theoretically calculated 100.5 μm. The linewidth of the terahertz source is determined to be approximately 42 GHz from FIG. 14.

The disclosed terahertz sources described above advantageously may be implemented in a compact design without the need for cryogenic cooling. Consequently, these improved designs enable terahertz sources to be incorporated into many commercial devices.

Although the systems and methods have been described in terms of exemplary embodiments, they are not limited thereto. Rather, the appended claims should be construed broadly, to include other variants and embodiments of the disclosed systems and methods, which may be made by those skilled in the art without departing from the scope and range of equivalents of the systems and methods.

What is claimed is:

1. An optical system, comprising:
a first gain medium configured to be excited by an energy source and in response generate a first optical signal having first and second wavelengths;
a Q-switch disposed adjacent to the first gain medium for generating a pulsed optical signal in response to receiving the first optical signal; and
a non-linear optical crystal configured to output a second optical signal having a frequency based on difference frequency generation of the first and second wavelengths of the pulsed optical signal.

2. The optical system of claim 1, further comprising:
a polarizer disposed adjacent to an output of the Q-switch and configured to divert a third optical signal having the first wavelength into a first arm and a divert a fourth optical signal having the second wavelength into a second arm; and
a beam splitter disposed between the non-linear optical crystal and the first and second arms, the beam splitter configured to combine the third and fourth optical signals to produce the pulsed optical signal.

3. The optical system of claim 2, wherein the first and second arms each include a lens for collimating one of the third and fourth optical signals and at least one mirror for directing one of the third and fourth optical signals towards the beam splitter.

4. The optical system of claim 2, wherein the first arm receives the third optical signal through a first output coupler, and the second arm receives the fourth optical signal through a second output coupler.

5. The optical system of claim 1, further comprising:
a second gain medium configured to be excited by a second optical source and in response generate a third optical signal; and
a polarizer disposed between the Q-switch and the first and second gain mediums, the polarizer configured to output a combination of the first and third optical signals to the Q-switch,
wherein the Q-switch generates the pulsed optical signal in response to receiving the combination of the first and third optical signals from the polarizer.

6. The optical system of claim 1, wherein the Q-switch is one of an active Q-switch and a passive Q-switch.

7. The optical system of claim 6, wherein the Q-switch includes both active and passive Q-switches.

8. The optical system of claim 1, wherein a frequency of the second optical signal is on an order of terahertz.

9. The optical system of claim 1, further comprising an etalon disposed between the Q-switch and the non-linear optical crystal for tuning the frequency of the second optical signal output by the non-linear optical crystal.

10. A method, comprising:
generating a first optical signal having first and second wavelengths in response to exciting a first gain medium;
switching the first optical signal to provide a pulsed optical signal having the first and second wavelengths; and
outputting a second optical signal from a non-linear optical crystal in response to receiving the pulsed optical signal, the second optical signal having a frequency based on difference frequency generation of the first and second wavelengths of the pulsed optical signal.

11. The method of claim 10, further comprising:
polarizing the first optical signal such that a third optical signal is directed into a first arm and a fourth optical signal is directed into a second arm; and
combining the third and fourth optical signals into the pulsed optical signal at a beam splitter disposed between the non-linear optical signal and the first and second arms.

12. The method of claim 11, further comprising:
collimating the third optical signal at a first lens disposed in the first arm;
collimating the fourth optical signal at a second lens disposed in the second arm;
reflecting the third optical signal towards the beam splitter at a first mirror disposed in the first arm; and
reflecting the fourth optical signal towards the beam splitter at a second mirror disposed in the second arm.

13. The method of claim 10, further comprising:
generating a third optical signal in response to exciting a second gain medium;
outputting a combination of the first and third optical signals from a polarizer disposed between the Q-switch and the first and second gain mediums,
wherein the Q-switch generates the pulsed optical signal in response to receiving the first and third optical signals.

14. The method of claim 10, further comprising adjusting the frequency of the second optical signal at an etalon disposed between the Q-switch and the non-linear optical crystal.

15. The method of claim 10, wherein the frequency of the second optical signal is on an order of terahertz.

16. An optical system, comprising:
a first energy source configured to output optical energy having a first wavelength;
a first gain medium configured to output a first optical signal having second and third wavelengths in response to receiving the optical energy from the first optical source;
a Q-switch disposed adjacent to the first gain medium for generating a pulsed optical signal in response to receiving the first optical signal; and
a non-linear optical crystal configured to output a second optical signal having a frequency on an order of terahertz based on difference frequency generation of the pulsed optical signal having the second and third wavelengths.

17. The optical system of claim 16, further comprising:
a polarizer disposed adjacent to an output of the Q-switch and configured to divert a third optical signal having the second wavelength into a first arm and a divert a fourth optical signal having the third wavelength into a second arm; and
a beam splitter disposed between the non-linear optical crystal and the first and second arms, the beam splitter configured to combine the third and fourth optical signals into the pulsed optical signal.

18. The optical system of claim 17, wherein the first and second arms each include a lens and at least one mirror for directing one of the third and fourth optical signals towards the beam splitter.

19. The optical system of claim 16, further comprising:
a second energy source configured to output optical energy having the first wavelength;
a second gain medium configured to output a third optical signal having the second and third wavelengths in response to receiving the optical energy from the second optical source; and
a polarizer disposed between the Q-switch and the first and second gain mediums, the polarizer configured to output a combination of the first and third optical signals to the Q-switch,
wherein the Q-switch generates the pulsed optical signal in response to receiving the combination of the first and third optical signals from the polarizer.

20. The optical system of claim 16, wherein the Q-switch is one of an active Q-switch and a passive Q-switch.
